(19) United States
(12) Patent Application Publication
(10) Pub. No.: US 2014/0358773 A1
(43) Pub. Date: Dec. 4, 2014

(54) ELECTRONIC BOOK SERVICE SYSTEMS, METHODS, AND INTERFACES

(71) Applicant: Brain Hive, LLC, Minneapolis, MN (US)

(72) Inventors: ADAM MORRIS LERNER, ST. PAUL, MN (US); DANIEL JOSEPH WALLEK, WHITE BEAR LAKE, MN (US); TERRI LYNN THERIAULT SOUTOR, EDEN PRAIRIE, MN (US)

(21) Appl. No.: 14/295,988

(22) Filed: Jun. 4, 2014

Related U.S. Application Data
(60) Provisional application No. 61/830,977, filed on Jun. 4, 2013.

(51) Int. Cl. G06F 3/0483; G06Q 40/00

(52) U.S. Cl. CPC G06F 3/0483; G06Q 40/00
USPC 705/39; 715/741

(57) ABSTRACT

Systems, methods, and graphical user interfaces for facilitating and using an electronic book service may include a plurality of settings and/or configurations.

### CROSS-REFERENCE TO RELATED APPLICATION

This application claims the benefit of U.S. Provisional Patent Application Ser. No. 61/830,977 filed on 4 Jun. 2013 and entitled “ELECTRONIC BOOK SERVICE SYSTEMS, METHODS, AND INTERFACES,” which is incorporated herein by reference in its entirety.

### BACKGROUND

The disclosure herein relates to electronic book service systems, methods, and interfaces. More particularly, the disclosure relates to systems, methods, and graphical user interfaces facilitating the administration and use of electronic book services.

Electronic books may be distributed to a variety of different electronic devices such as, e.g., personal computers, tablet computers, e-paper readers, etc. Some electronic books may be stored in electronic libraries that may be accessed (e.g., checked out) by users using an electronic book service. Generally, institutions or organizations, such as schools and universities, may subscribe to an electronic book service on a high fixed-fee, unlimited access basis. In other words, the customer, e.g., the institution or organization, may pay a high fixed fee such that each of its users has access to the electronic library.

### SUMMARY

The present disclosure describes electronic book systems and methods that provide graphical user interfaces to administer, manage, and/or use one or more electronic book services (e.g., to provide access to electronic books within electronic book libraries of the electronic book services). The electronic book systems and/or methods may provide customers access to one or more electronic book libraries on an on-demand basis (e.g., the customer may not be charged anything until a book is checked out by a user). To manage such on-demand electronic book libraries, the exemplary systems may provide various interfaces and methods for managing the one or more features associated with the on-demand electronic book service.

For example, the electronic book libraries may be curated by an administrator (e.g., a user with administrative, or elevated, privileges). Further, for example, the budget of a library account may be managed (e.g., edited, changed, enabled, disabled, etc.) by an administrator using various controls (e.g., input apparatus such as a webpage interface). Still further, for example, various settings for controlling user behavior may be managed by an administrator. Some information regarding the behavior of users such as what users are reading or checking out or information input by users such as notes, etc. may be shared with others. The exemplary systems, methods, and/or interfaces may further allow an administrator to control various sharing settings for the users (e.g., share settings related to what information may be shared between users). Further, the exemplary systems, methods, and/or interfaces may allow users to keep notes in electronic books, which may be shared to other users and/or moderated by an administrator.

One exemplary system for providing an electronic book service including a curation interface may include a display apparatus and a computing apparatus. The display apparatus may include a graphical user interface that is configured to depict a curation interface. The computing apparatus may be operatively coupled to the display apparatus and may be configured to store a plurality of library accounts and a plurality of users for each library account of the plurality of library accounts. Each library account of the plurality of library accounts may include curation information configured, e.g., to allow users access to one or more selected electronic books from a plurality of electronic books. The computing apparatus may be further configured to display on the graphical user interface the curation interface. The curation interface may be configured to allow an administrator to modify the curation information by selecting one or more electronic books of the plurality of electronic books to be accessible by the plurality of users of a library account of the plurality of library accounts.

One exemplary method of providing an electronic book service including a curation interface may include storing a plurality of library accounts and a plurality of users for each library account of the plurality of library accounts on a computing apparatus. Each library account of the plurality of library accounts may include curation information configured to allow users access to one or more selected electronic books from a plurality of electronic books. The exemplary method may include displaying on a graphical user interface a curation interface. The curation interface may be configured to allow an administrator to modify the curation information by selecting one or more electronic books of the plurality of electronic books to be accessible by the plurality of users of a library account of the plurality of library accounts.

In one or more exemplary systems and methods, the curation interface may be further configured to allow an administrator to modify the curation information by selecting a group of electronic books of the plurality of electronic books to be accessible by the plurality of users of a library account of the plurality of library accounts. In one or more exemplary systems and methods, the curation interface may be further configured to allow an administrator to modify the curation information by selecting one or more users of the plurality of users to have access to the one or more selected electronic books.

One exemplary system for providing an electronic book service including a budget interface may include display apparatus and a computing apparatus. The display apparatus may include a graphical user interface that is configured to depict a budget interface. The computing apparatus may be operatively coupled to the display apparatus and may be configured to store a plurality of library accounts and a plurality of users for each library account of the plurality of library accounts. Each library account of the plurality of library accounts may include a budget limit and a budget time period. The plurality of users for the library account may be restricted from spending more than the budget limit when checking out electronic books over a budget time period. The computing apparatus may be further configured to display on the graphical user interface the budget interface. The budget interface may be configured to allow an administrator to select and/or set the budget limit for a library account of the plurality of library accounts.

One exemplary method of providing an electronic book service including a budget interface may include storing a plurality of library accounts and a plurality of users for each library account of the plurality of library accounts on a computing apparatus. Each library account of the plurality of library accounts may include a budget limit and a budget time period. The plurality of users for the library account may be restricted from spending more than the budget limit when checking out electronic books over a budget time period. The exemplary method may further include displaying on the graphical user interface a budget interface. The budget interface may be configured to allow an administrator to select and/or set the budget limit for a library account of the plurality of library accounts.

In one or more exemplary systems and methods, the budget interface may be further configured to allow an administrator to select the budget time period for the library account of the plurality of library accounts. In one or more exemplary systems and methods, each library account of the plurality of library accounts may include billing information, and the budget interface may be further configured to allow an administrator to enter the billing information for the library account of the plurality of library accounts. In one or more exemplary systems and methods, the budget interface may be further configured to depict at least one of a graphical element representing the budget limit and an amount of the budget limit that has been spend in the budget time period and an alphanumeric representation of the amount of the budget limit that has been spend in the budget time period. In one or more exemplary systems and methods, each library account of the plurality of library accounts may include a balance value, and the budget interface may be further configured to depict a graphical element representing a pre-payment option configure to allow an administrator to enter a pre-payment to be credited to the balance value for the library account of the plurality of library accounts.

One exemplary system for providing an electronic book service may include display apparatus and a computing apparatus. The display apparatus may include a graphical user interface that is configured to depict a checkout settings interface. The computing apparatus may be operatively coupled to the display apparatus and may be configured to store a plurality of library accounts and a plurality of users for each library account of the plurality of library accounts. Each library account of the plurality of library accounts may include a checkout limit, and each user of the plurality of users may be restricted from checking out more electronic books than the checkout limit at the same time. The computing apparatus may be further configured to display on the graphical user interface the checkout settings interface. The checkout settings interface may be further configured to allow an administrator to select and/or set the checkout limit for a library account of the plurality of library accounts.

One exemplary method of providing an electronic book service including a checkout settings interface may include storing a plurality of library accounts and a plurality of users for each library account of the plurality of library accounts on a computing apparatus. Each library account of the plurality of library accounts may include a checkout limit, and each user of the plurality of users may be restricted from checking out more electronic books than the checkout limit at the same time. The exemplary method may further include displaying on the graphical user interface a checkout settings interface, and the checkout settings interface may be configured to allow an administrator to select and/or set the checkout limit for a library account of the plurality of library accounts.

In one or more exemplary systems and methods, each library account of the plurality of library accounts may include a consecutive checkout limit, and each user of the plurality of users may be restricted from consecutively checking out an electronic book more than the consecutive checkout limit. The checkout settings interface may be further configured to allow an administrator to select and/or set the consecutive checkout limit for a library account of the plurality of library accounts.

In one or more exemplary systems and methods, each library account of the plurality of library accounts may include a consecutive checkout time limit, and each user of the plurality of users may be restricted from having an electronic book checked out for longer than the consecutive checkout time limit. The checkout settings interface may be further configured to allow an administrator to select and/or set the checkout time limit for a library account of the plurality of library accounts. In at least one embodiment, the checkout settings interface may be configured to allow an administrator to set, or modify, each of the checkout limit, consecutive checkout limit, and checkout time limit for each grade level (e.g., such that members of each grade level will have access to the eBook library according to the limits corresponding to the grade at which the members are within). For example, the plurality of users for each library account of the plurality of library accounts may be grouped according to a plurality of grade levels, and the checkout settings interface may be configured to allow an administrator to set the checkout limit for each grade level of the plurality of grade levels for the library account.

One exemplary system for providing an electronic book service may include a display apparatus and a computing apparatus. The display apparatus may include a graphical user interface that is configured to depict a sharing settings interface. The computing apparatus may be operatively coupled to the display apparatus and may be configured to store a plurality of library accounts and a plurality of users for each library account of the plurality of library accounts. Each library account of the plurality of library accounts may include sharing settings, and each sharing setting of the one or more sharing settings may allow the computing apparatus to share checkout information of one or more users of the plurality of users with one or more other users of the plurality users. The computing apparatus may be further configured to display on the graphical user interface the sharing settings interface, and the sharing settings interface may be configured to allow an administrator to enable one or more sharing settings for a library account of the plurality of library accounts.

One exemplary method of providing an electronic book service including a checkout settings interface may include storing a plurality of library accounts and a plurality of users for each library account of the plurality of library accounts on a computing apparatus. Each library account of the plurality of library accounts may include sharing settings, and each sharing setting of the one or more sharing settings may allow the computing apparatus to share information of one or more users of the plurality of users with one or more other users of the plurality users. The exemplary method may further include displaying on the graphical user interface a sharing settings interface that is configured to allow an administrator to enable one or more sharing settings for a library account of the plurality of library accounts.

In one or more exemplary systems and methods, the sharing settings may include a presently-reading setting that, when enabled, may allow the computing apparatus to share what each user is presently-reading with one or more users of the plurality of users. In one or more exemplary systems and methods, the sharing settings may include a ratings setting that, when enabled, may allow each user of the plurality of users to rate each electronic book of a plurality of books and allows the computing apparatus to share the ratings of the plurality of electronic books by the plurality of users with one or more users of the plurality of users. In one or more exemplary systems and methods, the sharing settings may include a favorites setting that, when enabled, may allow each user of the plurality of users to mark one or more electronic books as favorites and may allow the computing apparatus to share what one or more electronic books each user has marked as a favorite with one or more users of the plurality of users. In one or more exemplary systems and methods, the sharing settings may include a notes setting that, when enabled, may allow the computing apparatus to share notes made by a user in one or more electronic books with one or more users of the plurality of users. In one or more exemplary systems and methods, the sharing settings may include a note moderation setting that, when enabled, allows the administrator to moderate notes made, or input, by the plurality of users in one or more electronic books.

One exemplary system for providing an electronic book service may include a display apparatus and a computing apparatus. The display apparatus may include a graphical user interface that is configured to depict a note moderation interface. The computing apparatus may be operatively coupled to the display apparatus and may be configured to store a plurality of library accounts and a plurality of users for each library account of the plurality of library accounts. Each library account of the plurality of library accounts may include note information for each book of a plurality books. The computing apparatus may be further configured to display on the graphical user interface the note moderation interface that is configured to allow an administrator to moderate (e.g., edit, review, change, delete, etc.) the note information made by one or more users for one or more books of the plurality of books for a library account of the plurality of library accounts.

One exemplary method of providing an electronic book service may include storing a plurality of library accounts and a plurality of users for each library account of the plurality of library accounts. Each library account of the plurality of library accounts may include note information for each book of a plurality books. The exemplary method may further include displaying on a graphical user interface a note moderation interface that is configured to allow an administrator to moderate the note information made by one or more users for one or more books of the plurality of books for a library account of the plurality of library accounts.

In one or more exemplary systems, the computing apparatus may be further configured to facilitating the checking out of one or more electronic books of a plurality of electronic books to one or more users for each library account of the plurality of library accounts. In one or more exemplary methods, the exemplary method may further include facilitating the checking out of one or more electronic books of a plurality of electronic books to one or more users for each library account of the plurality of library accounts. Further, at least one library account may be configured to provide an electronic library for a school, and the administrator may be a librarian for the school.

The above summary of the present disclosure is not intended to describe each embodiment or every implementation thereof. Advantages, together with a more complete understanding of the present disclosure, will become apparent and appreciated by referring to the following detailed description and claims taken in conjunction with the accompanying drawings.

### BRIEF DESCRIPTION OF THE DRAWING

FIG. 1 is a block diagram of an exemplary system including input apparatus and display apparatus that may utilize the user interfaces and methods described herein.

FIG. 2 is a block diagram of an exemplary system including an electronic book service system, a plurality of user systems, and a content server system that may utilize the user interfaces and methods described herein.

FIG. 3 is a block diagram of a plurality of library accounts.

FIG. 4 is an exemplary graphical user interface including a login interface of an exemplary electronic book service.

FIG. 5 is an exemplary graphical user interface including a home interface of an exemplary electronic book service.

FIGS. 6-7 are exemplary graphical user interfaces including a “bookbag” interface of an exemplary electronic book service.

FIG. 8 is an exemplary graphical user interface including an electronic book detail screen of an exemplary electronic book service.

FIG. 9 is an exemplary graphical user interface including a page display screen of an exemplary electronic book service.

FIG. 10 is an exemplary graphical user interface including an administrator home interface of an exemplary electronic book service.

FIGS. 11-15 are exemplary graphical user interfaces including a curation interface of an exemplary electronic book service.

FIG. 16 is an exemplary graphical user interface including a budget interface of an exemplary electronic book service.

FIG. 17A is an exemplary graphical user interface including a checkout settings interface of an exemplary electronic book service.

FIG. 17B is an exemplary graphical user interface including a grade level settings interface of an exemplary electronic book service.

FIG. 18 is an exemplary graphical user interface including a sharing settings interface of an exemplary electronic book service.

FIGS. 19-20 are exemplary graphical user interfaces including a note moderation interface of an exemplary electronic book service.

FIGS. 21-22 are exemplary graphical user interfaces including an interest survey interface of an exemplary electronic book service.

### DETAILED DESCRIPTION OF EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

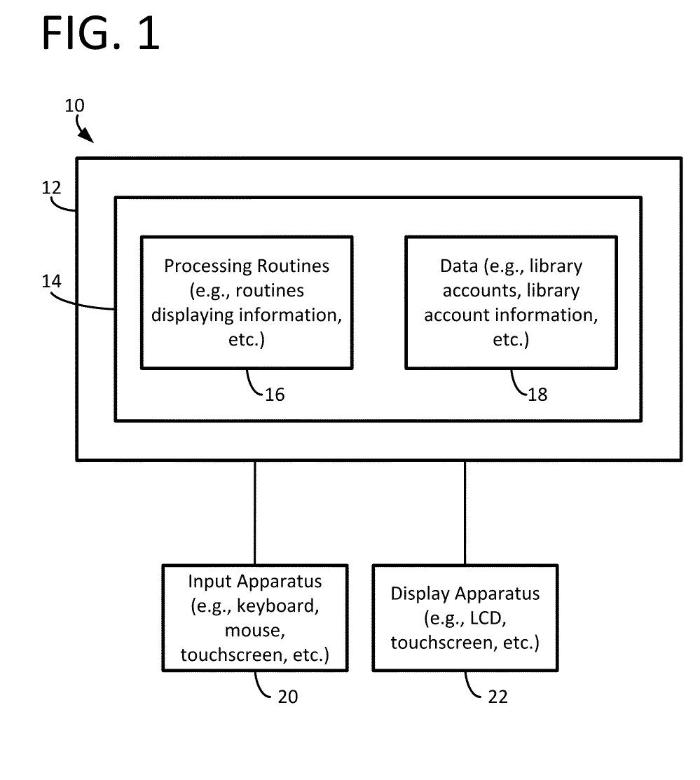

Exemplary systems and methods providing graphical user interfaces for an electronic book service shall be described with reference to FIGS. 1-20. It will be apparent to one skilled in the art that elements or processes from one embodiment may be used in combination with elements or processes of the other embodiments, and that the possible embodiments of such systems and methods using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

The exemplary systems, methods, and/or interfaces may provide an electronic book service. The electronic book service may provide schools (e.g., elementary schools, middle schools, junior high schools, high schools, colleges, universities, preparatory schools, pre-schools, etc.) and/or any other entity (e.g., such as libraries, etc.) an “on-demand” electronic book service where members or users such as, e.g., students, etc., may be provided access to electronic books. When an electronic book is “checked out” using an exemplary electronic book service described herein, a selected fee, e.g., $1.00, may be charged to the school or other entity. Using a sign-up interface displayed on a graphical user interface, an administrator such as, e.g., a school librarian, etc., may “sign-up,” or register, for a membership in the exemplary electronic book service and may further personalize an account in 15 minutes or less. For example, the administrator may select an electronic book collection, may curate an electronic book collection (e.g., select which electronic books may be available, or accessible, to the users of the system), set spending limits, configure payment options, and set, or configure, various user (e.g., student, etc.) access settings.

Additionally, administrators of the exemplary electronic book system such as, e.g., librarians, etc., may monitor the usage of the electronic book service and may monitor the account budget using various interfaces and reporting tools (e.g., graphical elements, etc.). In other words, administrators may have complete visibility of usage of the electronic book system and, it may be described, that the administrators may have, or be in, “complete control” of spending of the users of the electronic book system.

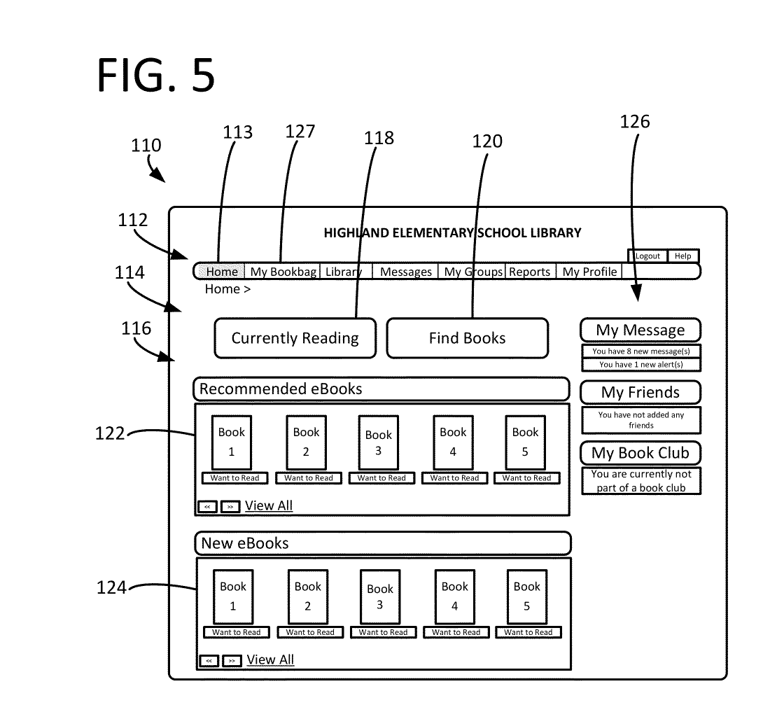

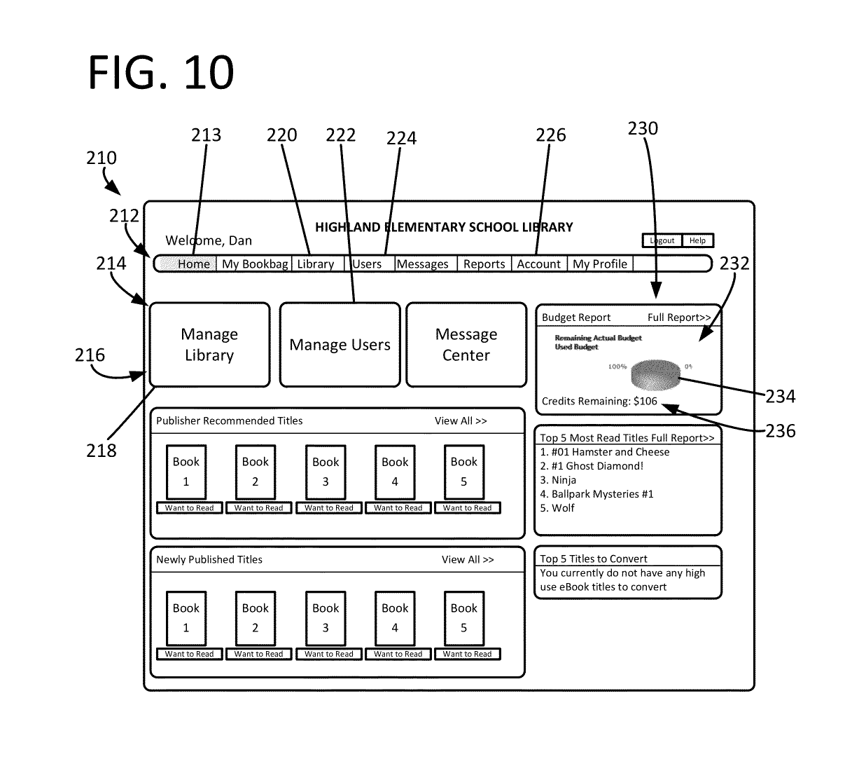

An exemplary system 10 depicted in FIG. 1 may be used to execute the exemplary methods and/or processes and to provide the exemplary graphical user interfaces described herein, e.g., to provide and/or manage an electronic book service. In at least one embodiment, the system 10 may be a server, a personal computer, or a tablet computer. As shown, the exemplary system 10 includes computing apparatus 12. The computing apparatus 12 may be configured to receive input from input apparatus 20 and transmit output to display apparatus 22. Further, the computing apparatus 12 may include data storage 14. Data storage 14 may allow for access to processing programs or routines 16 (e.g., for managing users accounts, for curating electronic book libraries and/or collections, for managing settings for one or more electronic book libraries and/or collections, for managing user settings for one or more users, etc.) and one or more other types of data 18 that may be employed to carry out exemplary methods and/or processes for use in facilitating an electronic book service (e.g., electronic book libraries or collections, user data and settings, sharing settings, budget information, etc.). For example, the computing apparatus 12 may be configured to display graphical users interfaces on the display apparatus 22 to allow users to use the electronic book service (e.g., some of which will be described further herein with respect to FIGS. 5-9 and 21-22) and to allow an administrator to adjust and/or set one or more settings related to the electronic book service such as, e.g., curation information, sharing settings, budget settings, note moderation, etc. (e.g., which will be described further herein with respect to FIGS. 10-20).

The computing apparatus 12 may be operatively coupled to the input apparatus 20 and the display apparatus 22 to, e.g., transmit data to and from each of the input apparatus 20 and the display apparatus 22. For example, the computing apparatus 12 may be electrically coupled to each of the input apparatus 20 and the display apparatus 22 using, e.g., analog electrical connections, digital electrical connections, wireless connections, bus-based connections, network-based connections, internet-based connections, etc. As described further herein, a user may provide input to the input apparatus 20 to manipulate, or modify, one or more graphical depictions displayed on the display apparatus 22 to view and/or adjust one or more settings associated with the exemplary book service described herein.

Further, various devices and apparatus may be operatively coupled to the computing apparatus 12 to be used with the computing apparatus 12 to facilitate the electronic book service as well as the functionality, methods, and/or logic described herein. As shown, the system 10 may include input apparatus 20 and display apparatus 22 operatively coupled to the computing apparatus 12 (e.g., such that the computing apparatus 12 may be configured to use information, or data, from the apparatus 20, 22 and provide information, or data, to the apparatus 20, 22). The input apparatus 20 may include any apparatus capable of providing input to the computing apparatus 12 to perform the functionality, methods, and/or logic described herein. For example, the input apparatus 20 may include a mouse, a keyboard, a trackball, a touchscreen (e.g., capacitive touchscreen, a resistive touchscreen, a multi-touch touchscreen, etc.), etc. The input apparatus 20 may allow a user to select and view various information and/or settings with respect to the electronic book service such as, e.g., electronic books, curated libraries electronic books, user settings, sharing settings, budget settings, etc., when used in conjunction with the display apparatus 22 (e.g., displaying a graphical user interface).

Likewise, the display apparatus 22 may include any apparatus capable of displaying information to a user, such as a graphical user interface, etc., to perform the functionality, methods, and/or logic described herein. For example, the display apparatus 22 may include a liquid crystal display, an organic light-emitting diode screen, a touchscreen, a cathode ray tube display, etc. As described further herein, the display apparatus 22 may be configured to display a graphical user interface that includes one or more various user interfaces to manage and/or administer an exemplary electronic book service. For example, the graphical user interfaces displayed by the display apparatus 22 may include, or display, one or more regions used to select and/or modify one or more settings with respect to an exemplary electronic book service. As used herein, a “region” of a graphical user interface may be defined as a portion of the graphical user interface within which information may be displayed or functionality may be performed. Regions may exist within other regions, which may be displayed separately or simultaneously. For example, smaller regions may be located within larger regions, regions may be located side-by-side, etc. Additionally, as used herein, an “area” of a graphical user interface may be defined as a portion of the graphical user interface located with a region that is smaller than the region it is located within.

The processing programs or routines 16 may include programs or routines for performing database management, user management, access control, financial processing, computational mathematics, comparison algorithms, or any other processing required to implement one or more exemplary methods and/or processes described herein. Data 18 may include, for example, library accounts, user accounts, library account information, user information, sharing information, social information, budgetary information, access control information, graphics (e.g., graphical elements, icons, buttons, windows, dialogs, pull-down menus, graphic areas, graphic regions, 3D graphics, etc.), graphical user interfaces, results from one or more processing programs or routines employed according to the disclosure herein, or any other data that may be necessary for carrying out the one and/or more processes or methods described herein.

In one or more embodiments, the system 10 may be implemented using one or more computer programs executed on programmable computers, such as computers that include, for example, processing capabilities, data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or methods as described herein or as would be applied in a known fashion.

The one or more programs used to implement the methods and/or processes described herein may be provided using any programmable language, e.g., a high level procedural and/or object orientated programming language that is suitable for communicating with a computer system. Any such programs may, for example, be stored on any suitable device, e.g., a storage media, that is readable by a general or special purpose program running on a computer system (e.g., including processing apparatus) for configuring and operating the computer system when the suitable device is read for performing the procedures described herein. In other words, at least in one embodiment, the system 10 may be implemented using a computer readable storage medium, configured with a computer program, where the storage medium so configured causes the computer to operate in a specific and predefined manner to perform functions described herein. Further, in at least one embodiment, the system 10 may be described as being implemented by logic (e.g., object code) encoded in one or more non-transitory media that includes code for execution and, when executed by a processor, is operable to perform operations such as the methods, processes, and/or functionality described herein.

Likewise, the system 10 may be configured at a remote site (e.g., an application server) that allows access by one or more users via a remote computer apparatus (e.g., via a web browser), and allows a user to employ the functionality according to the present disclosure (e.g., user accesses a graphical user interface associated with one or more programs to process data).

The computing apparatus 12 may be, for example, any fixed or mobile computer system (e.g., a controller, a microcontroller, a personal computer, mini computer, tablet computer, etc.). The exact configuration of the computing apparatus 12 is not limiting, and essentially any device capable of providing suitable computing capabilities and control capabilities (e.g., graphics processing, etc.) may be used.

As described herein, a digital file may be any medium (e.g., volatile or non-volatile memory, a CD-ROM, a punch card, magnetic recordable tape, etc.) containing digital bits (e.g., encoded in binary, trinary, etc.) that may be readable and/or writeable by computing apparatus 12 described herein.

Also, as described herein, a file in user-readable format may be any representation of data (e.g., ASCII text, binary numbers, hexadecimal numbers, decimal numbers, graphically, etc.) presentable on any medium (e.g., paper, a display, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware which is to be used to implement the processes described herein shall not be limiting on the scope of the systems, processes or programs (e.g., the functionality provided by such systems, processes or programs) described herein.

One will recognize that graphical user interfaces may be used in conjunction with the embodiments described herein. The graphical user interfaces may provide various features allowing for user input thereto, change of input, importation or exportation of files, or any other features that may be generally suitable for use with the processes described herein.

The methods and/or logic described in this disclosure, including those attributed to the systems, or various constituent components, may be implemented, at least in part, in hardware, software, firmware, or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems, devices and methods described in this disclosure may be embodied as instructions and/or logic on a computer-readable medium such as RAM, ROM, NVRAM, EEPROM, FLASH memory, magnetic data storage media, optical data storage media, or the like. The instructions and/or logic may be executed by one or more processors to support one or more aspects of the functionality described in this disclosure.

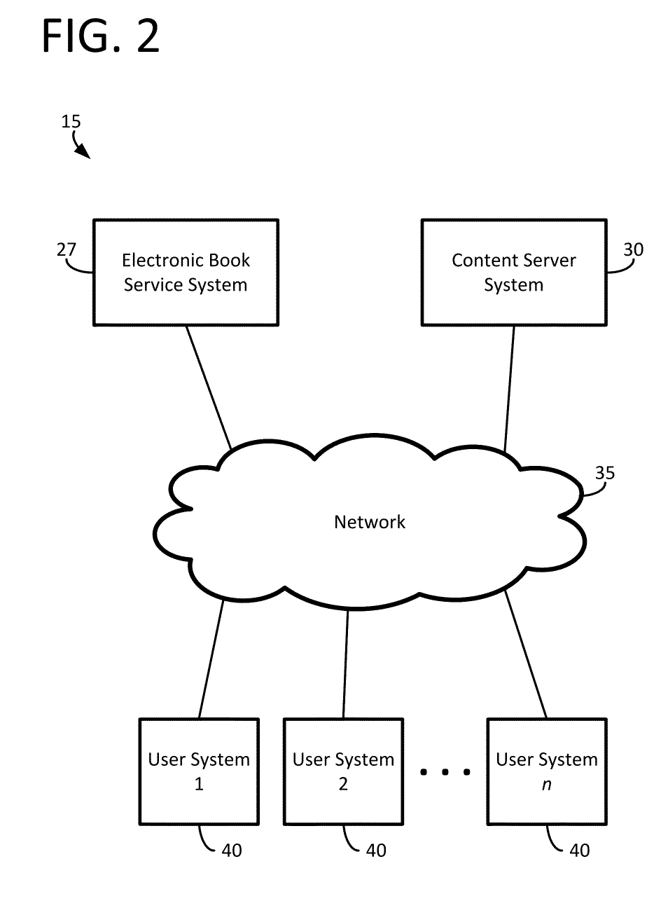

The exemplary system 10 may be an electronic book service system, a server system, and/or a user system. A system 15 including an electronic book service system 27, a content server system 30, and a plurality of user systems 40 is depicted in FIG. 2. Each of the electronic book service system 27, the content server system 30, and the plurality of user systems 40 may be connected to each other through a network 35. The network 35 may be the Internet, one or more local area networks, and/or any other type of network used to operatively couple computer systems such that the systems may communicate with, or transfer data between, each other. Although only a single electronic book service system 27 is depicted and a single content server 30 is depicted in the system 15, the system 15 may include more than one electronic books service system 27 and/or more than one content server system 30.

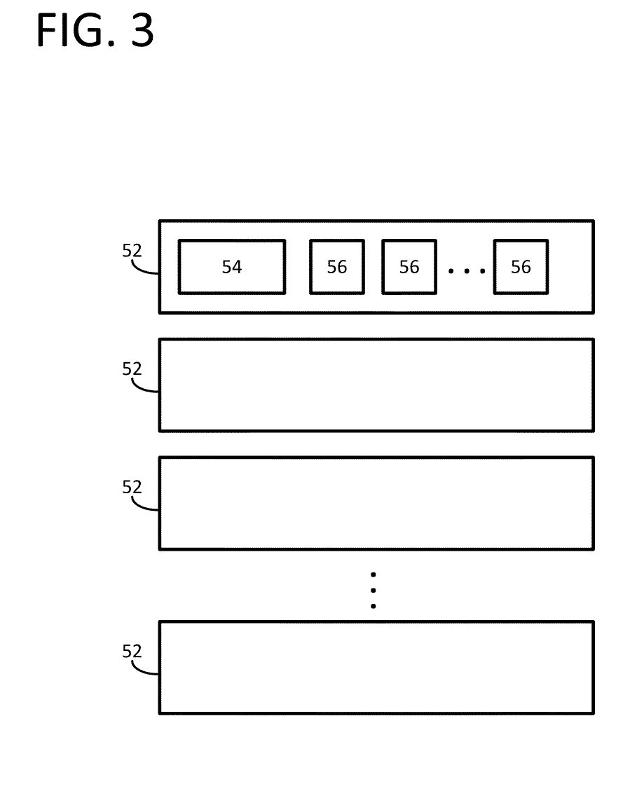

The electronic books service system 27 may facilitate the exemplary electronic book service described herein. For example, the system 27 may be configured to store a plurality of library accounts 52 (e.g., different libraries at the same or different schools, cities, etc.) as shown in FIG. 3 and a plurality of user accounts 56 (e.g., administrative users, school student users, municipality readers, etc.) for each library account 52. Additionally, each library account 52 may include one or more global settings and/or configurations 54 for the library account 52 such as, for example, curation information, budget settings, sharing settings, check-out settings, etc. associated with that particular library account 52. Further, each user account 56 of each library account 52 may have particular settings and/or configurations associated with that user account 56.

An administrator, such as, e.g., a librarian, etc., may log into the electronic book service system 27 and/or any user system 40 to use the exemplary book service. When an administrator logs on, a graphical user interface may be depicted on the display apparatus of the system (e.g., the system used to log into the exemplary book service) to configure the electronic book service. For example, one or more settings and configurations of the electronic book system 27 may be configured by the administrator using the graphical user interface.

Generally, when a user system 40 requests, or “checks out,” an electronic book, the user system 40 may request the electronic book from the electronic books service system 27, which may communicate with the content server 32 to deliver the electronic book to the user system 40.

It is to be understood that the depicted topology and configuration of the exemplary system 15 is not meant to restrict and/or limit the exemplary systems, methods, and/or described herein. Instead the exemplary system 15 is merely one example.

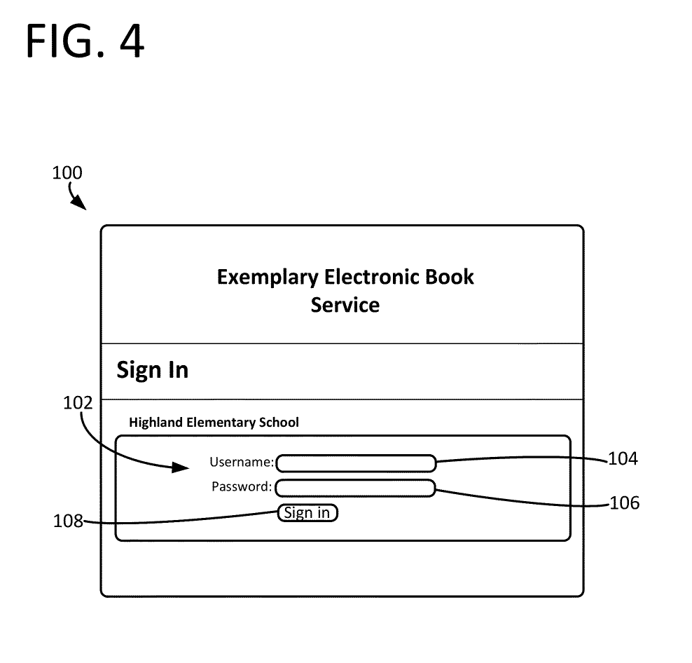

Exemplary graphical user interfaces for use in facilitating and/or using the exemplary electronic book service described herein are depicted in FIGS. 4-20. Such exemplary graphical user interfaces may be depicted by the display apparatus 22 of the system 10 described herein with reference to FIG. 1. Additionally, since each of the electronic book service system 27, the content server system 30, and the plurality of user systems 40 may be implemented by a system, such as system 10 described with reference to FIG. 1, each of the electronic book service system 27, the content server system 30, and the plurality of user systems 40 may include display apparatus similar to that of system 10, and thus, may be configured to depict the exemplary graphical user interfaces described herein. Further, it to be understood that the graphical user interfaces described herein may be displayed, or depicted, on a user system 40 while the electronic book service system 27 and/or content server system 30 may provide the graphical user interfaces to the user system 40 through, e.g., a network, etc. In at least one embodiment, the graphical user interfaces described herein may be depicted on a touchscreen, and in such configuration, the input apparatus would also be the touchscreen.

An exemplary graphical user interface 100 is depicted in FIG. 4 that may be generally used to “log in” to an exemplary electronic book service. The “log-in” graphical user interface 100 may be displayed when a user and/or administrator intends to use and/or administer the exemplary electronic book service. For example, the graphical user interface 100 may be displayed, or depicted, when a user navigates to a website to use the exemplary electronic book service. Further, for example, the graphical user interface 100 may be depicted when a user opens, or runs, a computer program (e.g., an “app” on a tablet computer) configured for use with the exemplary electronic book service. The user may use the graphical user interface 100 to “log in” to the exemplary electronic book service. Depending on the privileges of the user as verified by the entered login information, the exemplary electronic book service may display various information and/or additional graphical user interfaces as will be further described herein.

The graphical user interface 100 may include, among other regions, a login region 102. The login region 102 may be the region of the graphical user interface 100 that is configured for the user to input their username, input their password, and then sign-in to the electronic book service. For example the login region 102 may include a username area 104 that may be configured for the user to input their username using an input device such as a keyboard, and may include a password area 106 that may also be configured for the user to input their password using an input device such as a keyboard. After the username and the password have been inputted using the username area 104 and the password area 106, the user may select (e.g., click, touch, etc.) a sign-in area 108 (e.g., a button, etc.) to sign into or attempt to sign into the exemplary electronic book service.

In the example of a school library, a user may be a student, and thus, may not have administrator access to various controls and/or settings of the library account such as, e.g., budget information, library curation information, etc. Instead, the student may have access to one or more electronic book collections of the library account that have been configured for student access by an administrator. For example, the student may be allowed to “check out” and/or read any books from the one or more electronic book collections in the library account provided by the electronic book service.

Further, in the example of a school library, a user may be an administrator, and thus, the administrator may have administrator access to various controls and/or settings of the library account such as, e.g., budget information, library curation information, etc. Thus, when an administrator “logs in” using the graphical user interface 100, the administrator may be given access to the exemplary electronic book service and/or graphical user interfaces that is different than would be given, or provided to, a non-administrator user.

Various exemplary graphical user interfaces that may be depicted, or displayed, to a user that does not have administrator access, such as a student, to allow the user to use the electronic book service are shown in FIGS. 5-9. Further, various exemplary graphical user interfaces that may be depicted, or displayed to a user that does have administrator access, such as a librarian, to allow the user to manage and/or administer the electronic book service (e.g., modify or adjust one or more library accounts and/or settings associated with each library account) are shown in FIGS. 10-20.

A graphical user interface 110 of an exemplary electronic book service for a user that does not have administrator access is depicted in FIG. 5. The graphical user interface 110 may include a tool bar region 112 extending near the top of the graphical user interface 110 configured to allow the user to navigate through the graphical user interface 110.

The graphical user interface 110 may further include a main region 114 located below the tool bar region that is configured to depict various interfaces, e.g., depending on the navigation selection in the tool bar region 112. In this particular example, a home area 113 is shown to be selected (e.g., highlighted, etc.) in the tool bar region 112 indicating that the main region 114 depicts a home interface 116.

The home interface 116 may be depicted in the main region 114 automatically when a non-administrator logs into the electronic book service using the login graphical user interface 100 of FIG. 4. The home interface 116 may be described as providing a starting point for a user to access the electronic book service. For example, from the home interface 116, a user may select (e.g., click, touch, etc.) a “Currently Reading” area 118 to display one or more electronic books that the user is currently reading. Further, for example, from the home interface 116, a user may select a “Find Books” area 120 to display an interface to allow a user to browse and/or find books to read and/or check out.

The home interface 116 may further include a “Recommended eBooks” area 122 configured to display recommended electronic books that a user may check-out and/or read. The recommend electronic books that are displayed in the area 122 may be, e.g., based upon a user's preferences, an administrator's suggestion, a user's checkout history, etc. The home interface 116 may further include a “New eBooks” area 124 configured to display newly available electronic books (e.g., available to the user, available to all users, etc.) that a user may check-out and/or read.

The graphical user interface 110 may further include a status region 126 located to the right of the main region 114. The status region 126 may depict messages to and/or from the user and other users, friends of the user, and/or book club information with respect to the book clubs that the user may or may not belong to.

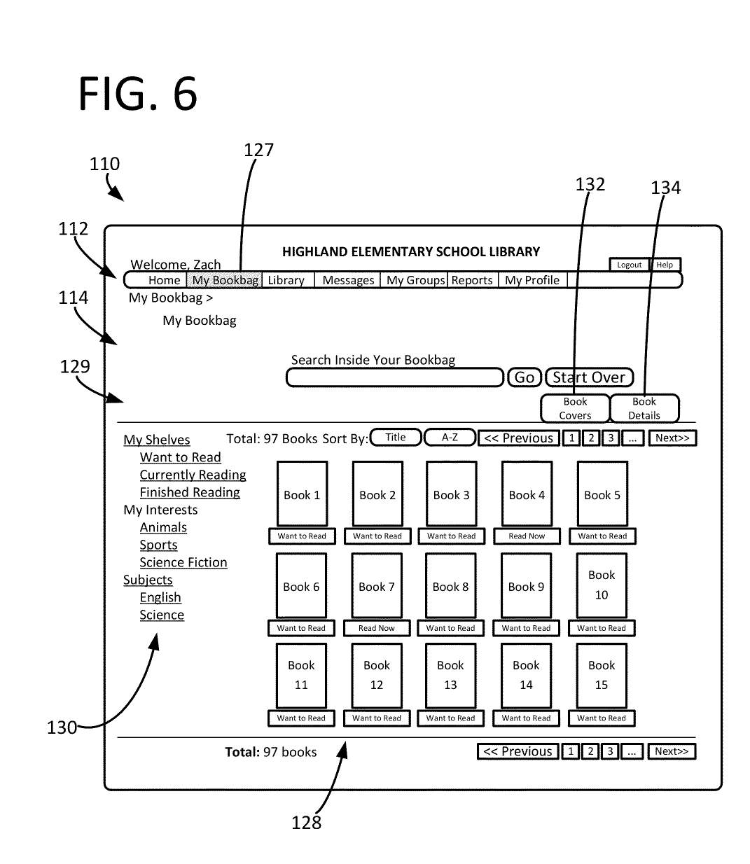

If a user selects (e.g., touches, clicks, etc.) the “My Bookbag” area 127 of the tool bar region 112, the main region 114 may depict a bookbag interface 129 that may include the electronic books 128 that the user may have accessed or may be presently accessing as shown in FIG. 6. As depicted, the user presently has 97 books in their “bookbag.” The “bookbag” can be sorted using one or more sort options located in the sort area 130 located to the left of the books 128. For example, a user may sort the electronic books using the sort area 130 by what the user wants to read, what the user is currently reading, what the user has finished reading, and/or by interest such as, e.g., Animals, Sports, Science Fiction, English, Science, etc.

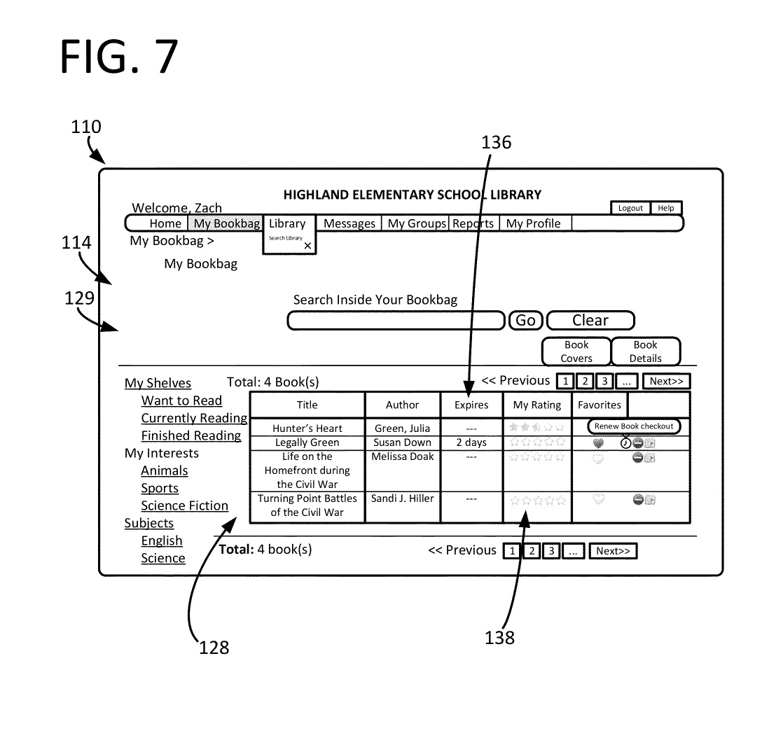

Additionally, as shown in FIG. 7, the electronic books 128 in the user's bookbag may be listed as opposed to graphically depicted as shown in FIG. 6. Further, a user may toggle between the views in FIG. 6 and FIG. 7 by selecting one of the view areas “Book Covers” 132 and “Book Details” 134 in the main region 114.

A user may choose to read an electronic book 128 by selecting an electronic book 128 from the bookbag interface 129 or one or more other interfaces as described herein. A user's ability to check out a book may be limited by one or more settings configured by an administrator. For example, a user may only checkout the same book a selected number of times in a row. As such, if a user has exceeded the checkout limit for a particular book, the user may not be allowed to select that particular book to checkout. Further, for example, a user may only be allowed to checkout a selected number of books at a time, and thus, if a user has exceeded or met the selected number of books that the user is allowed to check out, the user may not be allowed to select another book.

Each time a book is checked out by a user, a checkout time period may start. The checkout time period may be the period of time that a user is allowed to check out the electronic book. As shown in FIG. 7, the bookbag interface 129 may display how much time is left 136 for each electronic book that is checked out to a user. Additionally, each electronic book may be rated by the user, and the ratings 138 may be displayed proximate each electronic book as shown in FIG. 7

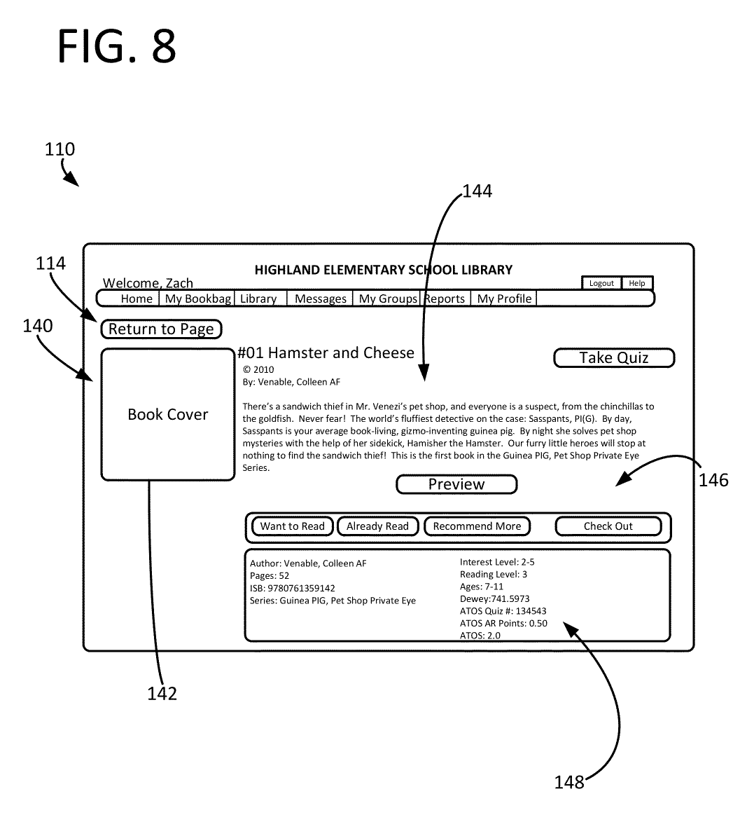

When a user selects an electronic book from the home interface 116 or the “bookbag” interface 129 of FIGS. 5-7, a book detail interface 140 may be depicted in the main region 114 of the graphical user interface 110 as shown in FIG. 8. As shown, the cover 142 of the electronic book may be displayed, a synopsis 144 of the electronic book may be displayed, one or more action areas 146 may be displayed, and additional information 148 (e.g., author, pages, ISBN, series, interest level, reading level, age recommendation, etc.) with respect to the electronic book may be displayed in the book detail interface 140.

The one or more action areas 146 may be configured to allow the user to perform one or more actions with respect to the selected electronic book. For example, as shown, a user may preview the electronic book, flag the electronic book as an electronic book the user would like to read, flag the electronic book as an electronic book that the user has already read, request recommendations from the electronic book service of more similar electronic books (e.g., same author, genre, type, etc.), and/or check out the electronic book.

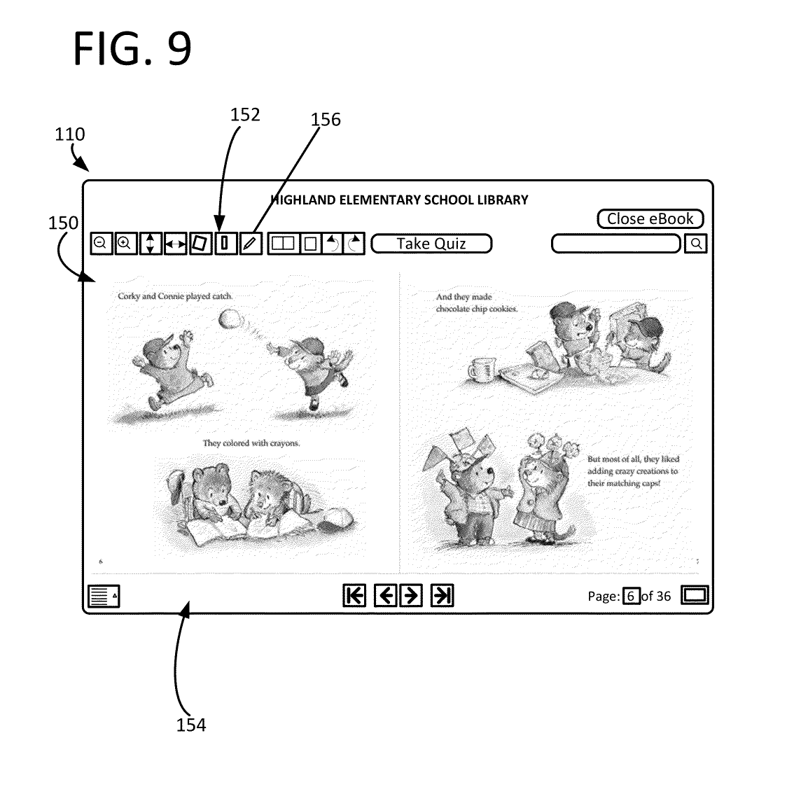

When a user is reading a “checked out” book, a page display interface 150 may be depicted in the graphical user interface 110 as shown in FIG. 9. More specifically, as shown, two pages of the book may be displayed side-by-side in page display interface 150. An upper control bar region 152 and a lower control bar region 154 may be depicted above and below the page display interface 150. The upper control bar region 152 may include multiple controls such as, e.g., zoom in, zoom out, expand horizontally (e.g., “fit to width”), expand vertically (e.g. “fit to height”), post a note to a page, book mark a page, highlight text, two page view, single page view, rotate page left or counterclockwise, rotate page right or clockwise, take a quiz, search, etc. The lower control bar region 154 may include various controls such as go to table of contents, return to beginning, back one page, forward one page, go to end, etc.

When the “post a note” area 156 of the upper control bar region 152 is selected, the graphical user interface 110 may provide one or more graphical dialogs and/or interfaces configured to allow the user to write a note, e.g., using input apparatus such as a keyboard or a touchscreen keyboard, and pin, or associate, the note to the page of the electronic book. The notes pinned, or associated with, a particular page of an electronic book may be shared with other users depending on how an administrator has configured the electronic book service as further described herein.

A graphical user interface 210 of an exemplary electronic book service for a user has administrator access is depicted in FIG. 10. The graphical user interface 210 may include a tool bar region 212 extending near the top of the graphical user interface 210 configured to allow the administrator user to navigate through, or within, the graphical user interface 210. Further, it may be described that the tool bar region 212 may provide a plurality of selectable areas that an administrator may select to display one or more different interfaces, regions, areas, information, etc. within the graphical user interface 210.

As shown, the graphical user interface 210 further includes a main region 214 located below the tool bar region 212 that may be configured to depict various interfaces depending on the selection in the tool bar region 212. In this particular example, a home area 213 is shown to be selected (e.g., highlighted, tab pulled forward, etc.) in the tool bar region 212 indicating that the main region 214 depicts an administrator home interface 216.

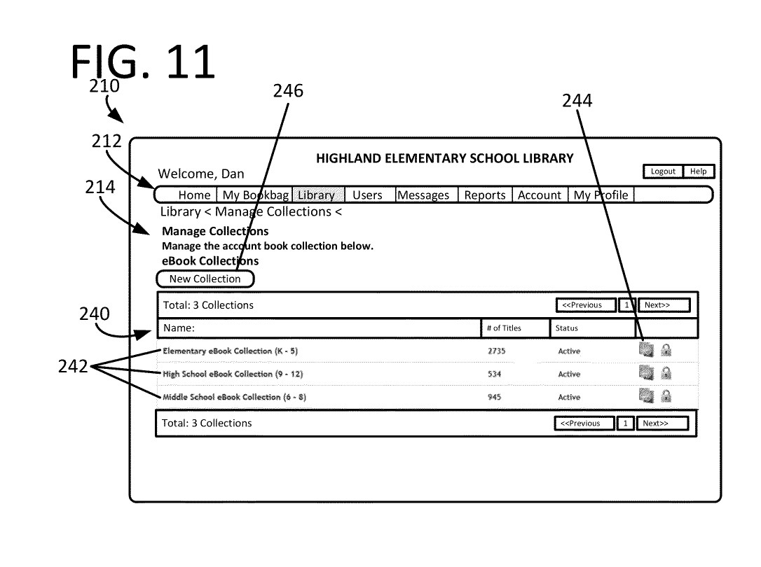

The administrator home interface 216 may be depicted in the main region 214 automatically when an administrator logs into the electronic book service using the login graphical user interface 100 of FIG. 4. The home interface 216 may provide a starting point, or portal, for an administrator to access the electronic book service and/or modify, or adjust, one or more settings or configurations of the electronic book service. For example, from the home interface 216, a user may select (e.g., click, touch, etc.) the “Manage Library” area 218 of the home interface 216 to display a curation interface as shown in FIGS. 11-14. Additionally, a user may select the “Library” area 220 of the tool bar region 212 to display the curation interface as shown in FIGS. 11-14.

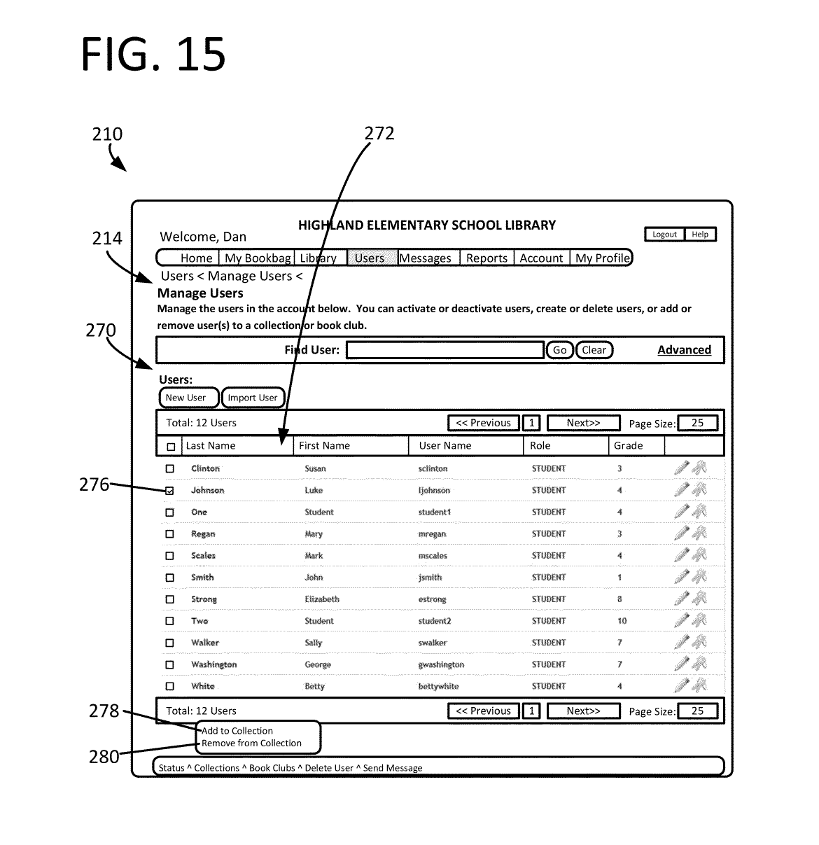

Further, for example, from the home interface 216, a user may select the “Manage Users” area 222 of the home interface 216 to display a user management interface as shown in FIG. 15. Additionally, a user may select the “Users” area 224 of the tool bar region 212 to display the user management interface as shown in FIG. 15.

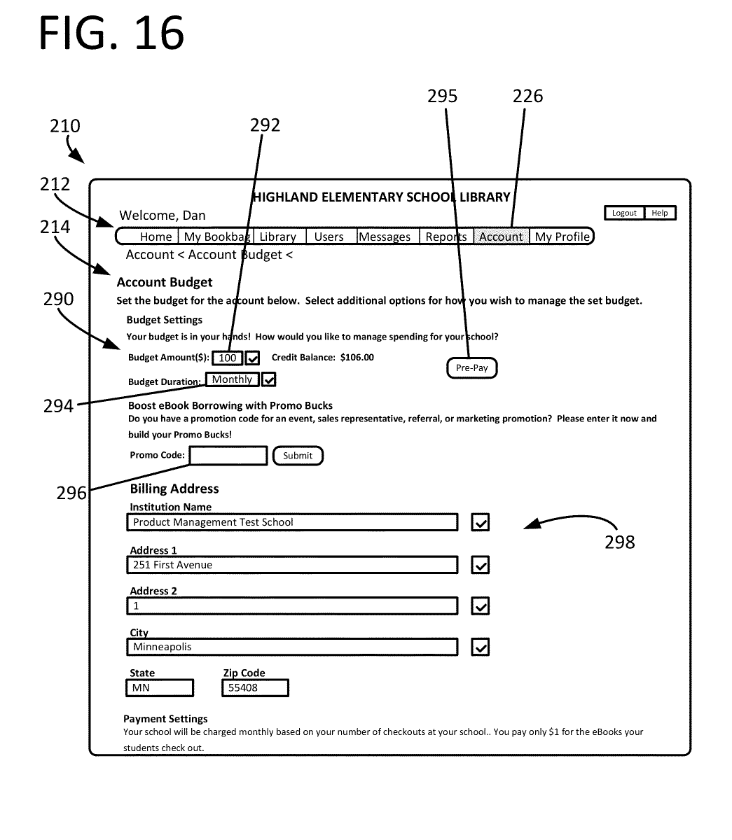

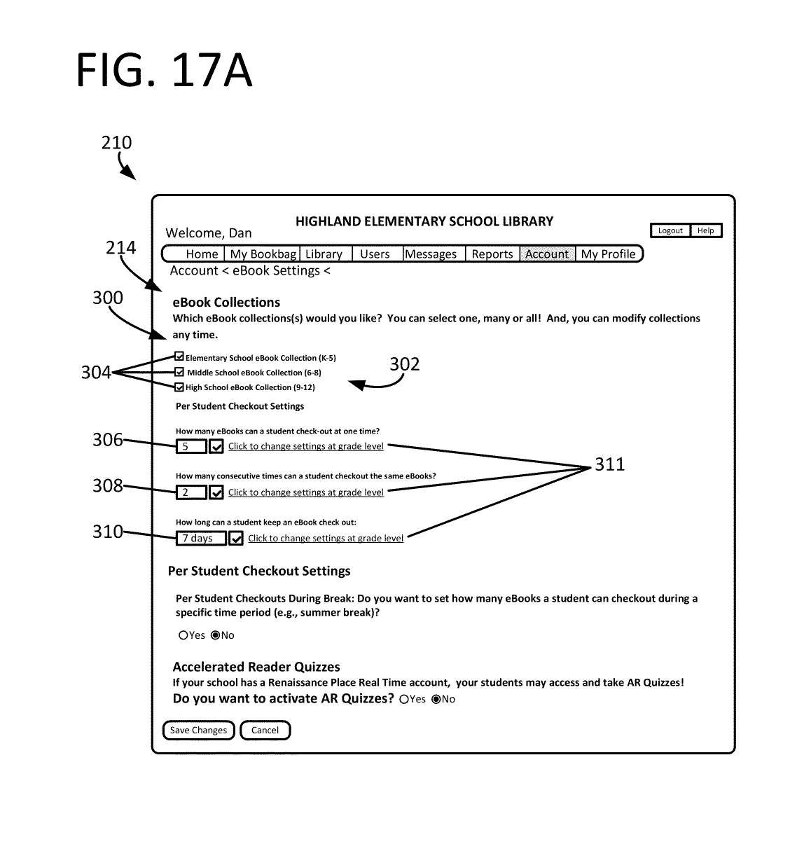

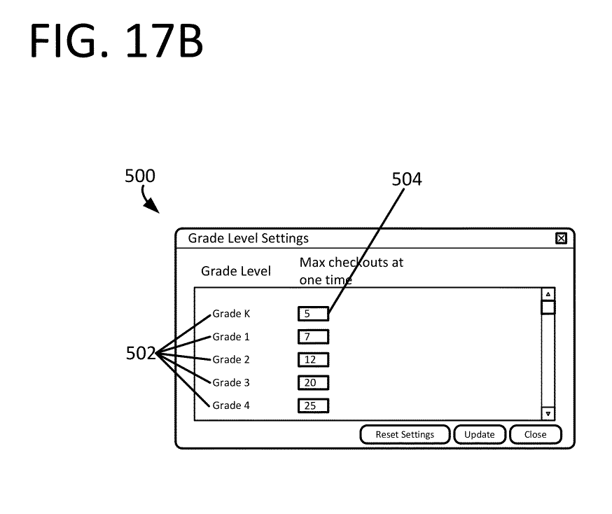

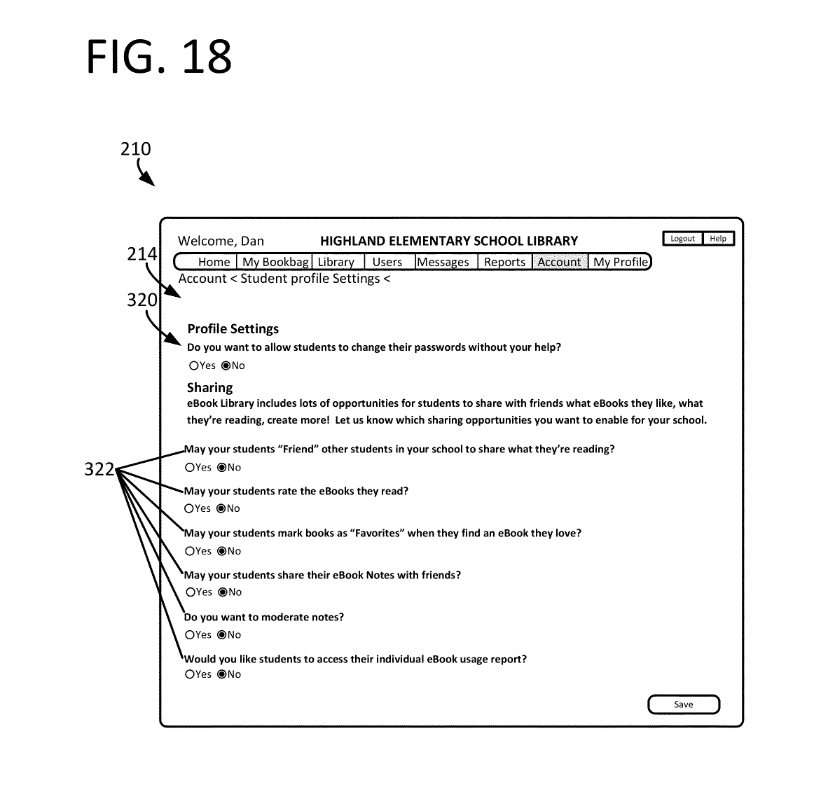

Still further, for example, from the home interface 216, a user may select the “Account” area 226 of the tool bar region 212 to display a budget interface as shown in FIG. 16, a checkout settings interface as shown in FIG. 17, and/or a sharing settings interface as shown in FIG. 18. More specifically, a menu may be displayed (e.g., a drop-down menu) when selecting the “Account” area 226 that includes additional areas, or links, associated with the budget interface, checkout settings interface, and share setting interface that may be selected to display to the budget interface, checkout settings interface, and share setting interface, respectively.

The graphical user interface 210 may further include a status region 230 located to the right of the main region 214. The status region 230 may depict one or more status, or informational, items related to the status of the electronic book service. As shown, budget information 232 for the account that the administrator is managing is displayed in the status region 230. More specifically, a graphical element 234 (e.g., a pie chart) representing a budget limit of the account and an amount of the budget limit that has been spent over a budget time period such as a month is depicted. Further, the budget information 232 further includes an alphanumeric representation 236 of an amount of the budget limit that is remaining for the budget time period. Additionally, the status region 230 may include the “Top 5 Most Read Titles,” the “Top 5 Titles to Convert” (e.g., which may be a list of the top 5 electronic books that have reached and/or exceeded a checkout threshold such that the exemplary system may recommend, or suggest, that they be purchased as opposed to being charged for each checked out), etc.

A curation interface 240 is depicted in the main region 214 of the graphical user interface 210 in FIGS. 11-14. Generally, the curation interface 240 may be configured to allow an administrator to modify curation information with respect to a library account (e.g., the library account associated with the particular administrator, etc.). The curation information may be configured to allow (or restrict) users' access to one or more electronic books from a plurality of electronic books available through the electronic book service. For example, the curation information may be used to limit particular collections or libraries to one or more particular, or selected, groups of users.

The curation interface 240 depicted in FIG. 11 is configured to allow an administrator to manage the collections 242 available to the users. Three different collections 242 are shown: “Elementary eBook Collection (K-5),” “High School eBook Collection (9-12),” and “Middle School eBook Collection (6-8).” Each collection 242 may include a plurality of electronic books that, e.g., have been selected for a target audience. For example, the “Elementary eBook Collection” may contain, or include, electronic books selected for elementary school students to read, the “High School eBook Collection” may contain, or include, electronic books selected for high school students to read, and the “Middle School eBook Collection” may contain, or include, electronic books selected for middle school students to read. Additionally, although not shown in FIG. 11, collections 242 may further include the following: “Grades PreK-2 ELA Common Core eBook Collection,” “Grades 3-5 ELA Common Core eBook Collection,” “Grades 6-8 ELA Common Core eBook Collection,” and “Grades 9-12 ELA Common Core eBook Collection.”

Each of the collections 242 may be managed and/or edited by selecting the collection. For example, a user may manage and/or edit a collection by selecting the collection title or another graphical element such as the graphical element 244 corresponding to the collection.

If a user would like to create a new collection, an administrator may select the “New Collection” area 246 of the interface 240. When an administrator elects to create a new collection, the administrator may select one or more electronic books from a plurality of electronic books available using the exemplary electronic book service to provide the collection.

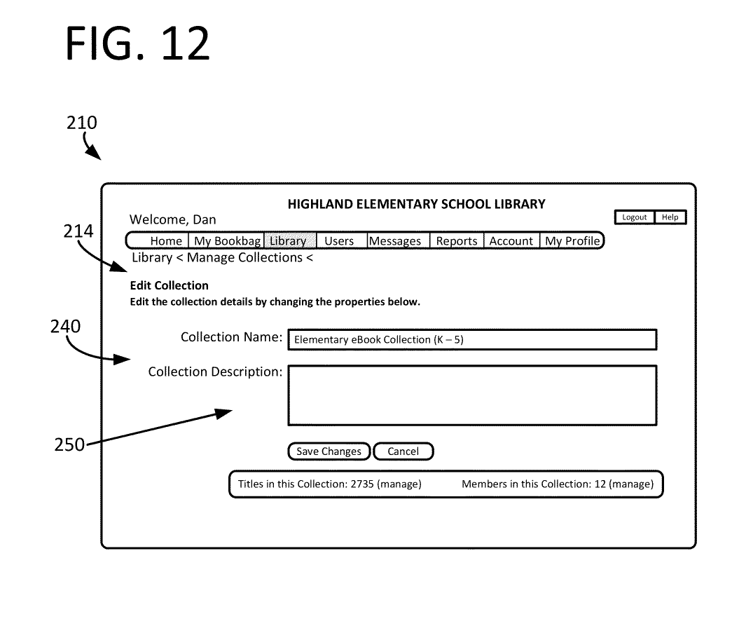

For example, when an administrator elects to manage or edit a collection, the curation interface 240 may depict an edit collection area 250 in the main region 214 as shown in FIG. 12. Using the edit collection area 250, an administrator may rename and/or add a description to the selected collection.

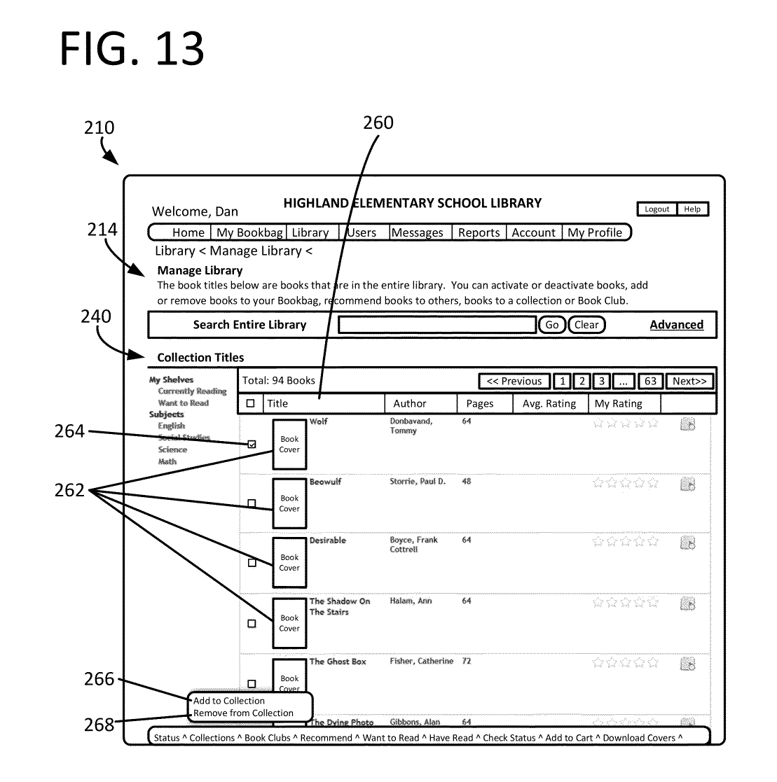

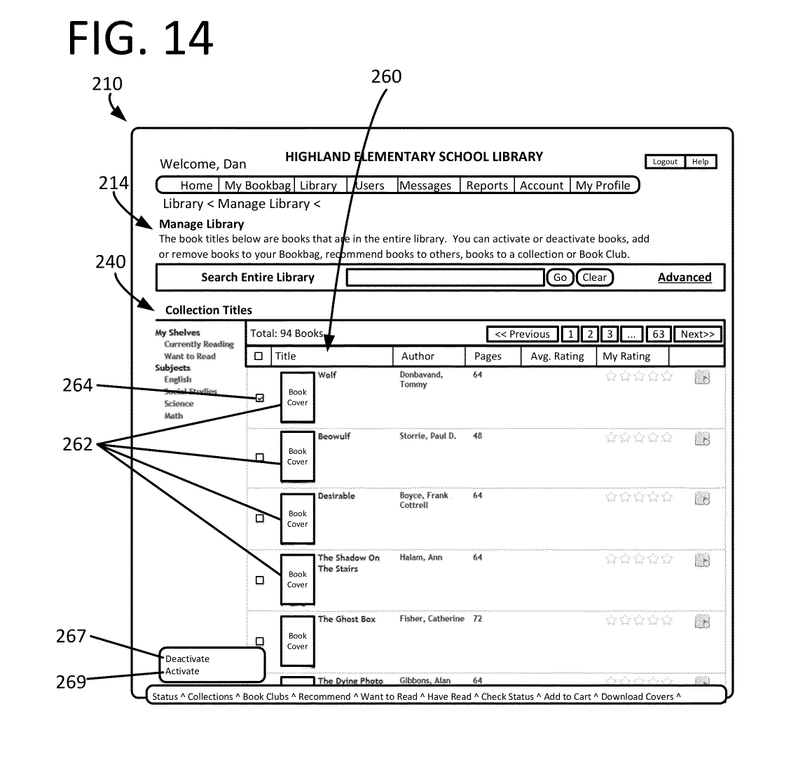

As described herein, an administrator may be able to modify the curation information by selecting one or more electronic books of the plurality of electronic books available from the electronic book service to be accessible by the plurality of users of the library account. To facilitate the selection of the one or more electronic books to be accessible, the curation interface 240 may provide a list 260 of the available electronic books 262 provided by the exemplary book service as shown in FIGS. 13-14.

As shown in FIG. 13, the administrator may browse a list of available electronic books and may select one or more electronic books that the administrator would like to add to the collection. For example, the administrator may select a checkbox graphical element 264 proximate a cover of each electronic book if that particular electronic book should be added, or removed, from the present collection. After one or more electronic books 262 have been selected, the administrator may add or remove the electronic books 262 from the collection by selecting an “Add to Collection” area 266 or “Remove from Collection” area 268, respectively, located below the list 260 of available electronic books.

Additionally, as shown in FIG. 14, after one or more electronic books 262 have been selected, an administrator may “activate” or “deactivate” one or more selected electronic books from the collection by selecting an “Active” area 269 or “Deactivate” area 267, respectively, located below the list 260 of available electronic books. If an electronic book is deactivated, the electronic book may not be available to the users but, e.g., may remain in the collection. If an electronic book is activated, the electronic book may be available to users to checkout and/or read. In other words, the “deactivate” feature may allow one or more electronic books to remain in the collection but not accessible to users such that, e.g., an administrator may not need to re-add the electronic books into the collection when the administrator desires to allow users to have access to such electronic books. It may be described that such books are “saved” in a collection for later use when “deactivated.”

An administrator may be able to modify the curation information by selecting one or more users to have access to one or more selected electronic books or collections of electronic books using a user management interface. An exemplary user management interface 270 is depicted in the main region 214 of the graphical user interface 210 in FIG. 15.

As shown, the administrator may browse a list of users 272 and select one or more users that the administrator would like to grant access to a particular collection or one or more selected books of a particular collection. For example, the administrator may select a checkbox graphical element 276 proximate the last name of each user that should be added, or removed, from the present collection. After one or more users have been selected, the administrator may add or remove the users from the collection by selecting an “Add to Collection” area 278 or a “Remove from Collection” 280, respectively, located below the list 272 of users.

Further, the exemplary systems and/or methods described herein may provide a budget limit for each library account. The budget limit may be the total amount of money available to the plurality of users of a library account over a budget time period. For example, when a user of a library account “checks out” a book, an amount such as, e.g., 1 dollar, may be charged to the budget of the library account. Once the budget limit has been reached over the budget time period, the exemplary book service may restrict users from checking out any more electronic books. In other words, the budget limit may restrict the users from spending more than the budget limit. The budget limit may allow administrators to have predictable expenditures per budget time period for providing the electronic book service.

The budget time period may be between about 1 day and about 1 year or a portion of a year. For example, the budget time period may be greater than or equal to 1 day, greater than or equal to 2 days, greater than or equal to 3 days, greater than or equal to 1 week, greater than or equal to 2 weeks, greater than or equal to 1 month, greater than or equal to 2 months, greater than or equal to 3 months, greater than or equal to 4 months, greater than or equal to 6 months, etc. Further, for example, the budget time period may be less than or equal to 3 years, less than or equal to 2 years, less than or equal to 1 year, less than or equal to 6 months, less than or equal to 4 months, less than or equal to 3 months, less than or equal to 2 months, less than or equal to 1 months, etc.

A budget interface 290 may be depicted in the main region 214 of the graphical user interface 210 as shown in FIG. 16 when an administrator selects the “Account” area 226 of the tool bar region 212. Generally, the budget interface 290 may allow an administrator to select a budget amount, a budget time period, pre-pay the electronic book service, add any promotional codes for the electronic book service, and add billing information for the electronic book service.

For example, if an administrator would like to change the budget limit, the administrator may select a budget limit area 292 to enter/set a new, or adjust an existing, budget limit using, e.g., an input apparatus such as a keyboard or touchscreen keyboard. As shown in the budget limit area 292, the budget limit is presently set to $100. Further, for example, if an administrator would like to change the budget time period, the administrator may select the budget time period area 294 to set or adjust the budget time period (e.g., using a pull-down menu, etc.). As shown, the budget time period is presently set to a month or monthly.

If an administrator has received any promotional codes, the administrator may enter the promotional codes using a promotional code entry area 296. The promotional codes may include free money to be added to the library account's balance, a free trial period, etc. Additionally, an administrator may enter the billing information including payment information in a billing information area 298

Institutions or organizations may receive funding at different times that may not correspond to the budget time period, and as such, some institutions or organizations may want to pre-pay the electronic book service such that the budget limit may be deducted from a library account's balance or balance value after each budget time period. As such, the interface 290 may further include a pre-payment area 295 that may be selected by a user to pre-pay, or add/credit funds to, the balance of the library account.

Still further, a checkout settings interface 300 may be depicted in the main region 214 of the graphical user interface 210 as shown in FIG. 17. Generally, the checkout settings interface 300 may allow an administrator to select which electronic book collections may be available (e.g., to be curated and available to users), to select how many electronic books per user may be checked out at one time, to select how many consecutive times a user may check out an electronic book, to select how long a user may keep an electronic book checked out, and/or to select whether electronic reader quizzes may be enabled for users.

One or more electronic book collections 302 may be selected by selecting the checkbox graphical elements 304 located adjacent the electronic book collections 302. As shown, each of the “Elementary eBook Collection (K-5),” “High School eBook Collection (9-12),” and “Middle School eBook Collection (6-8)” are selected.

If an administrator would like change the checkout limit (e.g., how many electronic books a user may checkout at one time), the administrator may select a checkout limit area 306 to enter/set a new checkout limit or adjust an existing checkout limit using, e.g., an input apparatus such as a keyboard or touchscreen keyboard. As shown in the checkout limit area 306, the checkout limit is presently set to 5 electronic books. The checkout limit may limit the amount of eBooks a single user may check out at any given time. Further, if an administrator would like to change the consecutive checkout limit, the administrator may select a consecutive checkout limit area 308 to enter/set a new, or adjust an existing, consecutive checkout limit. As shown in the consecutive checkout limit area 308, the consecutive checkout limit is presently set to 2 (e.g., limit users to 2 consecutive “checkouts” of a particular book). Further, if an administrator would like to change the checkout time limit, the administrator may select a checkout time period area 310 to set or adjust the checkout time period (e.g., using a pull-down menu, etc.). As shown in the checkout time period area 310, the checkout time period is presently set to 7 days. The checkout time period may be an amount of time that a user may “checkout” a book before the book must be checked back in or is automatically checked back in.

Additionally, the checkout settings interface 300 may be configured to allow a user to adjust one or more of the checkout limit, the consecutive checkout limit, and the checkout time period for each grade level, e.g., such that each grade level may have different limits and time periods. In other words, administrators may have the ability to set the number of eBooks a student can check out at one time, the number of times a student can check out the same eBook consecutively, and the duration of the eBook check out for all students in their school and modify the settings to be different at each grade level. For example, the plurality of users for a particular library account may include users across a plurality of different grade levels. The grade level settings may be applied to the users grouped according to their respective grade levels.

In at least one exemplary embodiment, the checkout settings interface 300 may further include, or depict, grade level settings links 311 proximate each of the checkout limit area 306, the consecutive checkout limit area 308, and the checkout time period area 310. The grade level settings for each of the areas 306, 308, and 310 may be modified, or set, by selecting the corresponding grade level settings link 311.

Upon selection of a grade level settings link 311, a grade level settings interface 500 may be depicted on the graphical user interface as shown in FIG. 17B. In at least one embodiment, the grade level settings interface 500 may be depicted as floating over, or on, the checkout settings interface 300. The grade level settings interface 300 may be configured to allow an administrator to set each of the checkout limits, the consecutive checkout limits, and the checkout time periods for each grade level. As shown, a list of grade levels 502 may be depicted on the grade level settings interface 500 and a modifiable value 504 may be located proximate to each of the grade levels 502. For example, a user may select the value 504 and modifiable the value by entering a different value from that that is depicted.

The exemplary grade level settings interface 500 depicted in FIG. 17B is the grade level settings interface for checkout limits. As shown, the checkout limit, or max checkouts at one time, for grade K is 5, for grade 1 is 7, for grade 2 is 12, for grade 3 is 20, and for grade 4 is 25.

Each of the one or more users of each library account of the plurality of library accounts may generate various information with respect to their reading habits, checkout habits, what books they consider to be their favorites, what notes they are taking or posting in a particular electronic book, etc. Such information may be shared with other users with the exemplary graphical user interface to, e.g., provide recommendations to the other users, to see what other users are reading, to provide useful insight into the book they are reading, etc.

To control the sharing of such information, a sharing settings interface 320 may be depicted in the main region 214 of the graphical user interface 210 as shown in FIG. 18. Generally, the sharing settings interface 320 may allow an administrator to enable or disable various features associated with sharing information about one or more users and their reading/checkout habits with other users. More specifically, the information about one or more users may be displayed on the various graphical user interfaces when a user selects an electronic book to read or is reading an electronic book, e.g., using the graphical user interfaces of FIGS. 5-9.

For example, the sharing settings interface 320 may include a plurality of questions 322 that may be answered in the affirmative (e.g., yes) or negative (e.g., no) to enable a plurality of sharing features. If an administrator enables the “May your students ‘Friend’ other students in your school to share what they're a reading?” question, then one or more users may be able to see what their “friends” are reading (e.g., what their “friends” are reading may be displayed on the graphical user interface, a list of what their “friend” is reading may be displayed when the “friend” is selected on the graphical user interface, etc.). If an administrator enables the “May your students rate the eBooks they read?” question, then the one or more users may be able to rate each electronic book and such ratings may be displayed to all or some other users. In at least one embodiment, the ratings may be averaged for each electronic book. If an administrator enables the “May your students mark books as ‘Favorites’ when they find an electronic book they love?” question, then the books selected, or “marked,” as favorites by users may be displayed to other users.

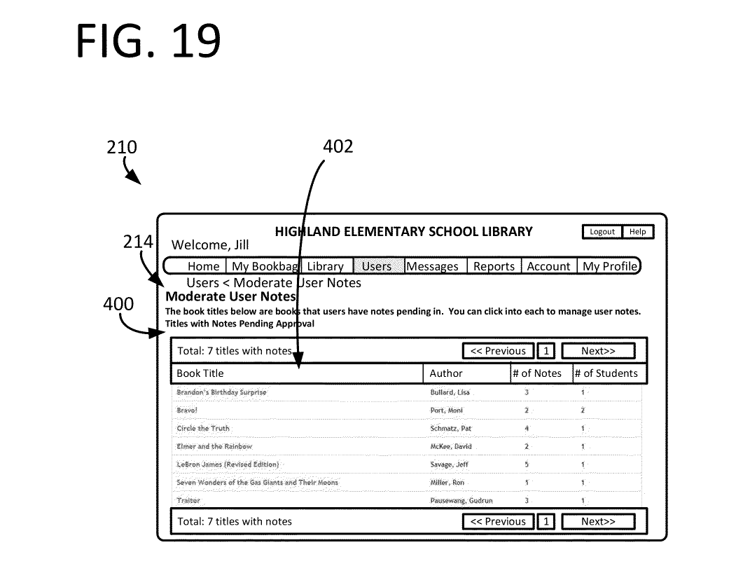

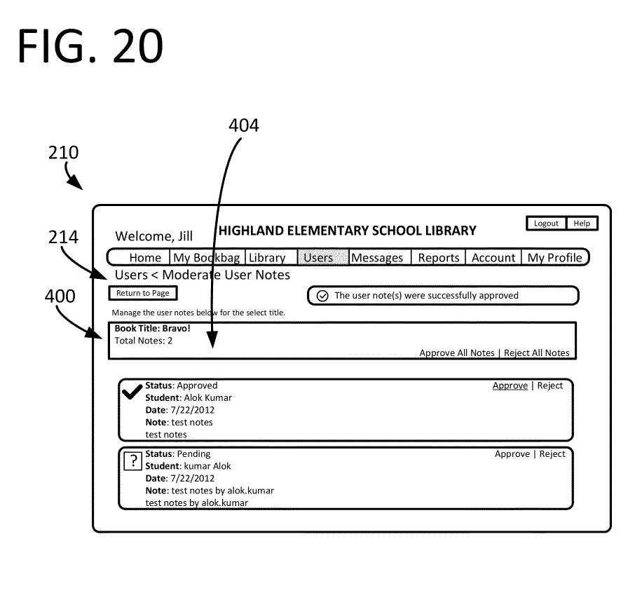

If an administrator enables the “May your students share their eBook Notes with friends?” questions, then any notes made by one or more users within one or more electronic books may be shared to other users when they are reading the electronic books that include notes. Users may make inappropriate notes within one or more electronic books, and as such, the notes may need to be moderated by an administrator. Thus, an administrator may enable the “Do you want to moderate students notes?” question, which activates a process by which each note may be moderated (e.g., accepted, rejected, modified, etc. using one or more various graphical user interfaces, etc.) by the administrator before being shared to the other users as will be shown in FIGS. 19-20.

If an administrator enables the “Would you like students to access their individual eBook usage report?” question, then users may be able to access their own usage reports to see various information with respect to the how they use the electronic book service. For example, a user may see how many electronic books they have checked out, how long they have checked out electronic books, etc.

As described herein, an administrator may be able to moderate (e.g., approve, delete, edit, etc.) the notes made by one or more users in one or more electronic books. To do so, a note moderation interface 400 may be depicted in the main region 214 of the graphical user interface 210 as shown in FIGS. 19-20. As shown in FIG. 19, a list of electronic books 402 in which one or more users have made notes is presented in the interface 400. The list of electronic books 402 may include the title of the book, the author, the number of notes made per book, and the number of students that made notes in the book.

An administrator may select an electronic book from the list 402 to moderate the notes made in that particular electronic book. After selection, a list of the notes 404 may be depicted in the note moderation interface 400 as shown in FIG. 20. Each note in the list 404 may include a status (e.g., pending, rejected, accepted, etc.), the name of the student that made the note, the date the note was made, and the note itself (as shown, one note is “test notes test notes”). An administrator may browse the notes in the list 404 and either approve or reject each of the notes (either one at a time, or all at once). As shown, the first note by “Alok Kumar” is indicated as being “Approved.” After a note is approved, any user who accesses that electronic book may view the approved note made by another user.

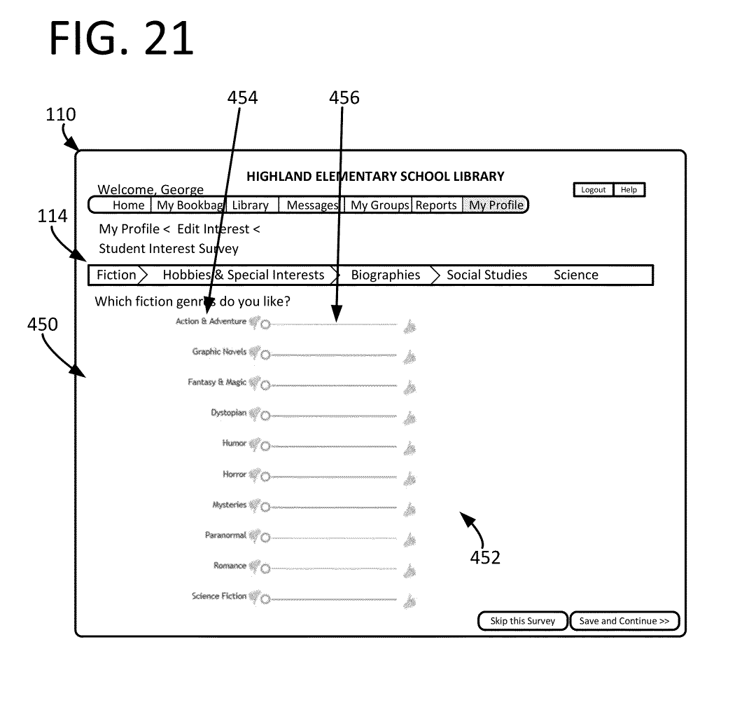

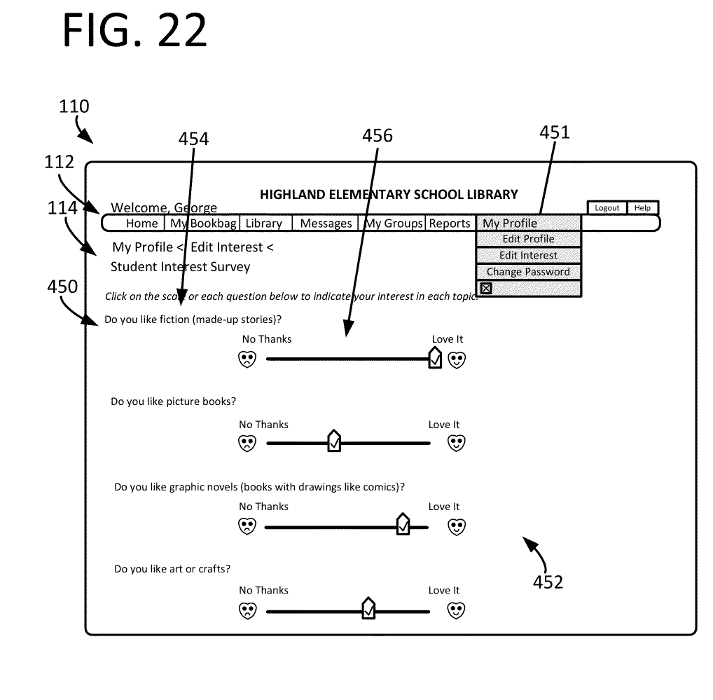

The exemplary electronic book service described herein may be customized, or personalized, to each user, e.g., using interest survey interfaces. Exemplary interest survey interfaces 450 are depicted in the main region 114 of the graphical user interface 110 in FIGS. 21-22. The survey interfaces 450 may be display upon the first time a user logs into the exemplary book service, or may be displayed by selected the “My Profile” area 451 in the tool bar region 112.

The survey interfaces 450 may include a plurality of survey items 452 that may include questions, interests, etc. that may be responded to by a user. Each survey item 452 may include a description 452 describing the item 452 and a slider 456 configured to allow the user to respond to the item 452. As shown in FIG. 21, each survey item 452 is a genre, and thus, the description 452 describes the genre (e.g., “Action & Adventure,” “Graphic Novels,” etc.), and a user may use the slider 456 to rate the genre from “I don't like” represented by a “thumbs down” graphical icon to “I like” represented by a “thumbs up” graphical icon.

As shown in FIG. 22, each survey item 452 is a question, and thus, the description 452 is the question itself (e.g., “Do you like fiction?,” “Do you like picture books?” etc.), and a user may use the slider 456 to rate their answer to the question from “No Thanks” represented by an apathetic heart face graphical icon to “Love It” represented by a smiley heart face graphical icon.

Each survey item 452 may provide customization, or personalization, data about the user to the exemplary book service, which may, in turn, customize, or personalize, one or more interfaces (e.g., such the interfaces as shown in FIGS. 5-9) for the user. For example, the home interface 116 may depict electronic books that are recommended by the exemplary book service based upon the data gathered using the survey interfaces 450. More specifically, if a user indicated in the survey interfaces that he/she likes mystery books, one or more interfaces described herein may display more mystery books than typically displayed. In other words, a user (e.g., a student) may rate how much they like specific interests and based on the results of their interests, the recommended electronic books on the user's home page may be adjusted.

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the systems and methods described herein. Various modifications of the illustrative embodiments, as well as additional embodiments of the disclosure, will be apparent upon reference to this description.

What is claimed is:

1. A method of providing an electronic book service including a curation interface comprising:
storing a plurality of library accounts and a plurality of users for each library account of the plurality of library accounts on a computing apparatus, wherein each library account of the plurality of library accounts comprises curation information configured to allow users access to one or more selected electronic books from a plurality of electronic books, and
displaying on a graphical user interface a curation interface, wherein the curation interface is configured to allow an administrator to modify the curation information by selecting one or more electronic books of the plurality of electronic books to be accessible by the plurality of users of a library account of the plurality of library accounts.

2. The method of claim 1, wherein the curation interface is further configured to allow an administrator to modify the curation information by selecting a group of electronic books of the plurality of electronic books to be accessible by the plurality of users of a library account of the plurality of library accounts.

3. The method of claim 1, wherein the curation interface is further configured to allow an administrator to modify the curation information by selecting one or more users of the plurality of users to have access to the one or more selected electronic books.

4. The method of claim 1, further comprising providing a system for providing the electronic book service, wherein the system comprises:
a display apparatus to depict the graphical user interface; and
the computing apparatus operatively coupled to the display apparatus, wherein the computing apparatus is configured to display the graphical user interface on the display apparatus.

5. A method of providing an electronic book service including a budget interface comprising:
storing a plurality of library accounts and a plurality of users for each library account of the plurality of library accounts on a computing apparatus, wherein each library account of the plurality of library accounts comprises a budget limit and a budget time period, wherein the plurality of users for the library account are restricted from spending more than the budget limit when checking out electronic books over a budget time period, and
displaying on the graphical user interface a budget interface, wherein the budget interface is configured to allow an administrator to set the budget limit for a library account of the plurality of library accounts.

6. The method of claim 5, wherein the budget interface is further configured to allow an administrator to select the budget time period for the library account of the plurality of library accounts.

7. The method of claim 5, wherein each library account of the plurality of library accounts comprises billing information, wherein the budget interface is further configured to allow an administrator to enter the billing information for the library account of the plurality of library accounts.

8. The method of claim 5, wherein the budget interface is further configured to depict at least one of a graphical element representing the budget limit and an amount of the budget limit that has been spend in the budget time period, and an alphanumeric representation of the amount of the budget limit that has been spend in the budget time period.

9. The method of claim 5, wherein each library account of the plurality of library accounts comprises a balance value, wherein the budget interface is further configured to depict a graphical element representing a pre-payment option configure to allow an administrator to enter a pre-payment to be credited to the balance value for the library account of the plurality of library accounts.

10. The method of claim 5, further comprising providing a system for providing the electronic book service, wherein the system comprises:
a display apparatus to depict the graphical user interface; and
the computing apparatus operatively coupled to the display apparatus, wherein the computing apparatus is configured to display the graphical user interface on the display apparatus.

11. A method of providing an electronic book service including a checkout settings interface comprising:
storing a plurality of library accounts and a plurality of users for each library account of the plurality of library accounts on a computing apparatus, wherein each library account of the plurality of library accounts comprises a checkout limit, wherein each user of the plurality of users is restricted from checking out more electronic books than the checkout limit at the same time, and
displaying on the graphical user interface a checkout settings interface, wherein the checkout settings interface is configured to allow an administrator to set the checkout limit for a library account of the plurality of library accounts.

12. The method of claim 11, wherein each library account of the plurality of library accounts comprises a consecutive checkout limit, wherein each user of the plurality of users is restricted from consecutively checking out an electronic book more than the consecutive checkout limit, wherein the checkout settings interface is further configured to allow an administrator to set the consecutive checkout limit for a library account of the plurality of library accounts.

13. The method of claim 11, wherein each library account of the plurality of library accounts comprises a consecutive checkout time limit, wherein each user of the plurality of users is restricted from having an electronic book checked out for longer than the consecutive checkout time limit, wherein the checkout settings interface is further configured to allow an administrator to set the checkout time limit for a library account of the plurality of library accounts.

14. The method of claim 11, wherein the plurality of users for each library account of the plurality of library accounts are grouped according to a plurality of grade levels, wherein the checkout settings interface is configured to allow an administrator to set the checkout limit for each grade level of the plurality of grade levels for the library account.

15. The method of claim 11, further comprising providing a system for providing the electronic book service, wherein the system comprises:
a display apparatus to depict the graphical user interface; and
the computing apparatus operatively coupled to the display apparatus, wherein the computing apparatus is configured to display the graphical user interface on the display apparatus.

16. A method of providing an electronic book service including a checkout settings interface comprising:
storing a plurality of library accounts and a plurality of users for each library account of the plurality of library accounts on a computing apparatus, wherein each library account of the plurality of library accounts comprises sharing settings, wherein each sharing setting of the one or more sharing settings allows the computing apparatus to share information of one or more users of the plurality of users with one or more other users of the plurality users, and
displaying on the graphical user interface a sharing settings interface, wherein the sharing settings interface is configured to allow an administrator to enable one or more sharing settings for a library account of the plurality of library accounts.

17. The method of claim 16, wherein the sharing settings comprises a presently-reading setting that, when enabled, allows the computing apparatus to share what each user is presently-reading with one or more users of the plurality of users.

18. The method of claim 16, wherein the sharing settings comprises a ratings setting that, when enabled, allows each user of the plurality of users to rate each electronic book of a plurality of books and allows the computing apparatus to share the ratings of the plurality of electronic books by the plurality of users with one or more users of the plurality of users.

19. The method of claim 16, wherein the sharing settings comprises a favorites setting that, when enabled, allows each user of the plurality of users to mark one or more electronic books as favorites and allows the computing apparatus to share what one or more electronic books each user has marked as a favorite with one or more users of the plurality of users.

20. The method of claim 16, wherein the sharing settings comprises a notes setting that, when enabled, allows the computing apparatus to share notes made by a user in one or more electronic books with one or more users of the plurality of users.

21. The method of claim 16, wherein the sharing settings comprises a note moderation setting that, when enabled, allows the administrator to moderate notes made by the plurality of users in one or more electronic books.

22. The method of claim 16, further comprising providing a system for providing the electronic book service, wherein the system comprises:
a display apparatus to depict the graphical user interface; and
the computing apparatus operatively coupled to the display apparatus, wherein the computing apparatus is configured to display the graphical user interface on the display apparatus.

23. A method of providing an electronic book service including a note moderation interface comprising:
storing a plurality of library accounts and a plurality of users for each library account of the plurality of library accounts, wherein each library account of the plurality of library accounts comprises note information for each book of a plurality books; and
displaying on a graphical user interface a note moderation interface, wherein the note moderation interface is configured to allow an administrator to moderate the note information made by one or more users for one or more books of the plurality of books for a library account of the plurality of library accounts.

24. The method of claim 23, wherein the method further comprises facilitating the checking out of one or more electronic books of a plurality of electronic books to one or more users for each library account of the plurality of library accounts, wherein at least one library account is configured to provide an electronic library for a school, and wherein the administrator is a librarian for the school.

25. The method of claim 23, further comprising providing a system for providing the electronic book service, wherein the system comprises:
a display apparatus to depict the graphical user interface; and
the computing apparatus operatively coupled to the display apparatus, wherein the computing apparatus is configured to display the graphical user interface on the display apparatus.
